(19) United States
(12) Patent Application Publication
(10) Pub. No.: US 2016/0336136 A1
(43) Pub. Date: Nov. 17, 2016

(54) INTEGRAL COMPLEX SAFETY APPARATUS

(71) Applicant: JOINSET CO., LTD., Ansan-si (KR)

(72) Inventors: SUN-KI KIM, Gunpo-si (KR); DUK-HEE KIM, Gunpo-si (KR)

(21) Appl. No.: 15/151,683

(22) Filed: May 11, 2016

(30) Foreign Application Priority Data
May 13, 2015 (KR) 10-2015-0066386
Apr. 27, 2016 (KR) 10-2016-0051222

(51) Int. Cl. H01H 85/02; H01H 85/175; H01H 85/36

(52) U.S. Cl. CPC H01H 85/0241; H01H 85/36; H01H 85/175; H01H 2235/01

(57) ABSTRACT

Provided is an integral complex safety apparatus in which a first lead and a second lead are electrically connected by interposing a fusible body, a conductive member, and a resistor therebetween, and inside a housing, the first lead and the conductive member are electrically connected by a restoring force due to compression of a spring and the first lead and the conductive member are electrically separated by the fusion of the fusible body installed inside the housing.

### REFERENCE TO RELATED APPLICATIONS

This application claims the priority benefit of Korean Patent Application No. 10-2015-0066386 filed on May 13, 2015 and Korean Application No. 10-2016-0051222 filed on Apr. 27, 2016, the entire contents of which are incorporated herein by reference.

### FIELD OF THE INVENTION

The present invention relates to an integral complex safety apparatus, and more particularly, to an integral complex safety apparatus which is attached inside an electronic apparatus such as a mobile device or a charger, is capable of complexly protecting overheating, an overcurrent, a surge, or the like, and is easily assembled and manufactured.

### BACKGROUND OF THE INVENTION

In general, all electric and electronic products using electricity include the possibility of safety accidents or failure occurrences in electronic devices due to an abnormal overcurrent or an external surge. To prevent this, a current fuse or a disposable temperature fuse is being used.

Recently, as electronic devices are miniaturized and integrated, the danger of safety accidents such as fire or explosion of the devices caused by an overcurrent or overheating due to various causes such as deterioration in components in the devices, circuit short, or the like has been increasing day by day. In addition, a surge prevention measure has been gradually further required due to frequent occurrence of thunderstroke according to climatic change and surge introduction into electronic devices through a power cable.

Thus, the development of safety apparatus capable of complexly protecting overheating, an overcurrent, a surge, or the like is being demanded.

According to such demand, Korean Patent Publication No. 10-1389709 filed and registered by the present inventor discloses a complex protective component including a fuse resistor including a wire resistor, and a repetitive fuse connected to the fuse resistor in serial, the repetitive fuse including: a first lead terminal disposed at one side of a housing provided with an internal space; an insulating stator for fixing the first lead terminal while surrounding one portion of the first lead terminal; a spindle disposed inside the housing, electrically interrupted with the first lead terminal, and electrically connected to a bias spring; a main spring for electrically connecting the first lead terminal and the spindle, the main spring being provided between the first lead terminal and the spindle; and a bias spring for electrically interrupting the first lead terminal and the spindle, the bias spring being provided in the opposite side to the direction in which the main spring is positioned with respect to the spindle, wherein the second lead terminal is disposed to be electrically connected to the wire resistor, and the wire resistor is electrically connected to the housing or the bias spring.

However, according to the above-mentioned patent, there is a problem of a complicated structure because a structure, in which a repetitive fuse which is independently manufactured and a fuse resistor are disposed side by side and connected in serial to be molded by using an insulative resin, is provided.

Also, there is a disadvantage in that a process is complicated because one of both leads attached for winding a resistive wire is cut after winding, an additional lead is attached to a metal capsule adjacent to the other lead by a method such as electric welding, and bending or the like should be performed to arrange both leads which are asymmetrically complicated, and thus a problem occurs in that the sizes of components become large.

### SUMMARY OF THE INVENTION

An object of the present invention is to provide an integral complex safety apparatus capable of complexly protecting overheating, an overcurrent, a surge, or the like.

Another object of the present invention is to provide an integral complex safety apparatus having a simple structure, and being capable of reducing manufacturing costs.

A further another object of the present invention is to provide an integral complex safety apparatus which is simply assembled and can be automatically assembled.

A still another object of the present invention is to provide an integral complex safety apparatus in which components can be miniaturized without requiring bending of a lead.

According to an aspect of the present invention, there is provided an integral complex safety apparatus including: an insulating housing having one open end and provided with an internal space; a conductive member disposed in the internal space and extending to an outer surface of the housing; an insulating bushing inserted into and installed in the internal space from the opening; a first lead passing through and fixed to the insulating bushing; a spring disposed in the internal space; a fusible body disposed in the internal space; a resistor disposed on the outer surface of the insulating housing and electrically connected to the conductive member; and a second lead coupled to the other end of the housing and electrically connected to the resistor, wherein the first lead and the conductive member are electrically connected to each other by a restoring force due to compression of the spring and the first lead and the conductive member are electrically separated from each other by the melting of the fusible body.

The fusible body may be coupled to the spring such that while a predetermined portion of the spring is extended, the fusible body is applied to the predetermined portion of the spring to surround the predetermined portion and is cured, whereby both ends of the spring may respectively contact the first lead and the conductive member.

The fusible body may be inserted into an inside of the spring from one end of the spring such that one portion thereof may be exposed to the outside, the other end of the spring may contact the conductive member, the one end of the spring may contact the bushing to be blocked by the bushing, and a protruded portion of the fusible body may contact the first lead by a restoring force due to compression of the spring.

The integral complex safety apparatus may further include a mover movably disposed in the internal space, wherein the spring may include a main spring interposed between the mover and the first lead to be supported by the mover, and a bias spring interposed between the mover and the conductive member, wherein the fusible body may be interposed between the bias spring and the conductive member or between the bias spring and the mover.

One end of the spring and one end of the fusible body may be disposed in serial so as to contact each other, the other end of the spring may contact the conductive member, and the other end of the fusible body may contact the first lead, and an extending length of the spring may be smaller than a length of the fusible body due to the melting of the fusible body.

One end of the spring and one end of the fusible body may be disposed in serial so as to contact each other, the other end of the spring may contact the first lead, and the other end of the fusible body may contact the conductive member, and an extending length of the spring may be smaller than a length of the fusible body due to the melting of the fusible body.

The spring may be a plate spring including a cylindrical sidewall and a plurality of forks spaced apart from each other, the forks extending from an upper end of the cylindrical sidewall to the inside of the spring, and a lower end of the cylindrical sidewall may contact the conductive member, and the one end of the fusible body may be elastically supported by the forks.

The conductive member may include a cylindrical body having an opening formed at one end thereof and a bottom formed on the other end thereof, and a connection part bent outward from an edge of the opening toward the other end to be integrally formed at the one end.

The second lead may include a rod-shaped body part, and a cup-shaped coupling part integrally formed at one end of the body part such that the coupling part may be coupled to the other end of the housing.

The fusible body may be a temperature fuse or a solder including a solder pellet or a solder ball.

The resistor may be a wire resistor both ends of which are electrically connected to the conductive member and the second lead respectively, and which is wound in a coil shape on an outer surface of the housing.

According to another aspect of the present invention, there is provided an integral complex safety apparatus including: an insulating housing having one open end and provided with an internal space; a conductive member disposed in the internal space and extending to an outer surface of the housing; an insulating bushing inserted into and installed in the internal space from the open end; a first lead passing through and fixed to the insulating bushing; a mover movably installed in the internal space; a main spring interposed between the mover and the first lead to be supported by the mover, and formed of a shape memory alloy; a bias spring interposed between the mover and the conductive member; a resistor installed on the outer surface of the housing and electrically connected to the conductive member; and a second lead coupled to the other end of the housing and electrically connected to the resistor, wherein the first lead and the conductive member are electrically connected by a restoring force due to compression of the spring and the first lead and the conductive member are electrically separated by deformation of the main spring.

### BRIEF DESCRIPTION OF THE DRAWINGS

The above objects and other advantages of the present invention will become more apparent by describing in detail exemplary embodiments thereof with reference to the attached drawings in which:

FIG. 1 is an exploded perspective view of a complex safety apparatus according to an embodiment of the inventive concept;

FIG. 2A illustrates a normal state, and FIG. 2B illustrates an electrically disconnected state;

FIG. 3 is a perspective view illustrating an insulating housing;

FIG. 4 is a perspective view illustrating a conductive member;

FIG. 5 is a perspective view illustrating a bushing;

FIGS. 6A and 6B respectively illustrate a first lead and a second lead;

FIG. 7 is a perspective view illustrating a mover;

FIG. 8 illustrates an example in which the fusible body in FIG. 2A is disposed at another position;

FIG. 9 illustrates a complex safety apparatus according to another embodiment of the present invention;

FIG. 10A illustrates a normal state of a complex safety apparatus according to another embodiment of the present invention, and FIG. 10B illustrates an electrically disconnected state;

FIG. 11A illustrates a normal state of a complex safety apparatus according to another embodiment of the present invention, FIG. 11B illustrates an electrically disconnected state, and FIG. 11C illustrates another example;

FIG. 12A illustrates a normal state of a complex safety apparatus according to another embodiment of the present invention, and FIG. 12B illustrates an electrically disconnected state;

FIG. 13A illustrates a normal state of a modified example in which the fusible body in FIG. 12A is disposed at another position, and FIG. 13B illustrates an electrically disconnected state;

FIG. 14A illustrates a normal state of a complex safety apparatus according to another embodiment of the present invention, and FIG. 14B illustrates an electrically disconnected state; and

FIG. 15 illustrates an example of a plate spring applied in FIG. 14A.

### DETAILED DESCRIPTION OF THE INVENTION

Now, exemplary embodiments of the present invention will be described in detail with reference to the accompanying drawings. However, embodiments described herein are provided so that the present invention may be fully understood by those skilled in the art, and may be embodied in different forms, and it should be understood that the scope of the invention is not limited to the embodiments described below. In the drawings, like reference numerals refer to like elements throughout.

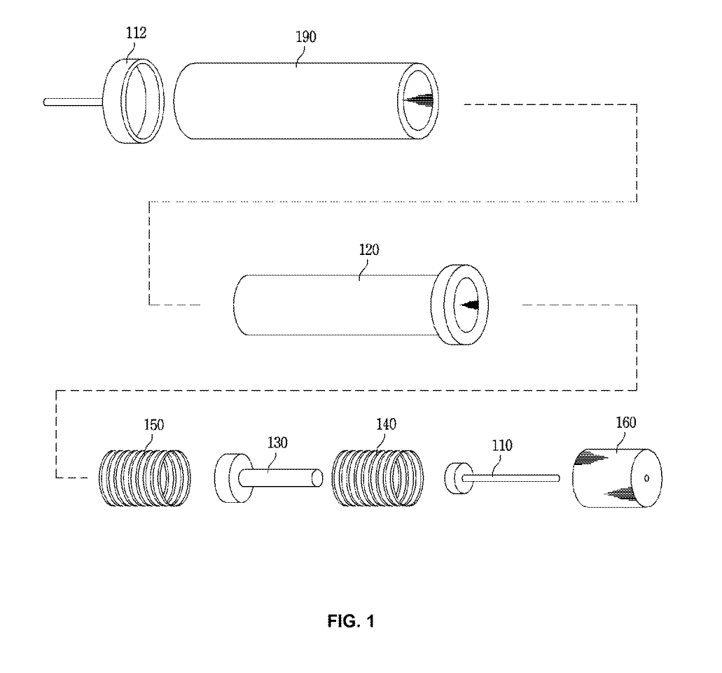

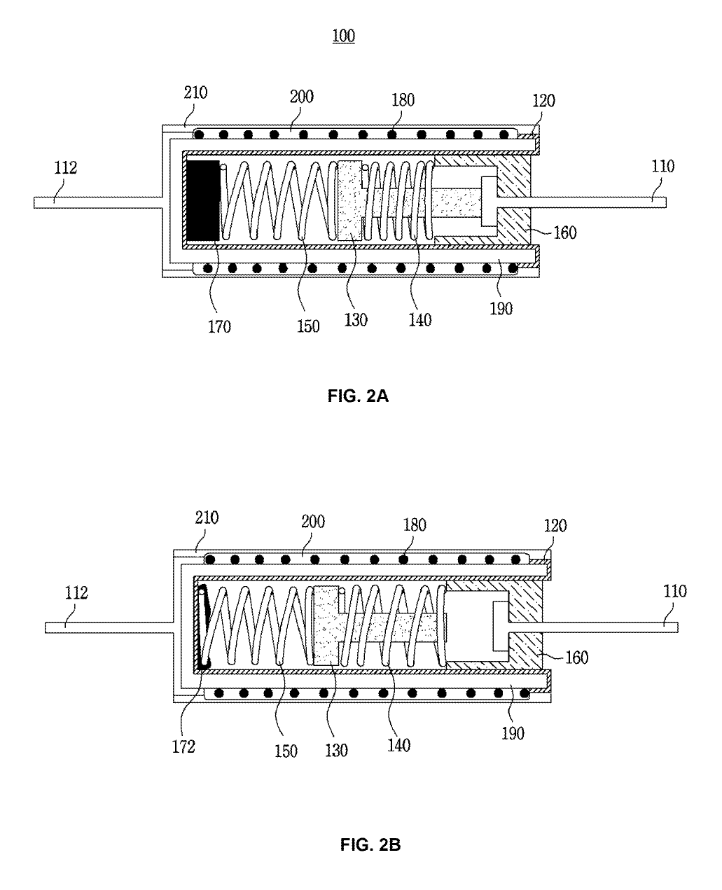

FIG. 1 is an exploded perspective view of a complex safety apparatus according to an embodiment of the inventive concept, FIG. 2A illustrates a normal state, and FIG. 2B illustrates an electrically disconnected state.

A complex safety apparatus 100 includes: an insulating housing 190 having one open end and provided with an internal space; a conductive member 120 disposed in the internal space; an insulating bushing 160 inserted into and installed in the internal space from the open end; a first lead 110 passing through and fixed to the insulating bushing; a mover 130 movably disposed in the internal space; a main spring 140 one end of which is fixed to the mover 130 between the mover 130 and the first lead 110; a bias spring 150 one end of which is fixed to the mover 130 between the mover and a bottom of the internal space; a fusible body 170 disposed on the bottom of the internal space and contacting the other end of the bias spring 150 so as to be pressed by the spring; a resistor 180 disposed on an outer circumferential surface of the insulating housing 190 and electrically connected to the conductive member 120; and a second lead 112 electrically connected to the resistor 180.

Hereinafter, each of the elements will be described in detail with reference to the drawings.

<Insulating Housing 190>

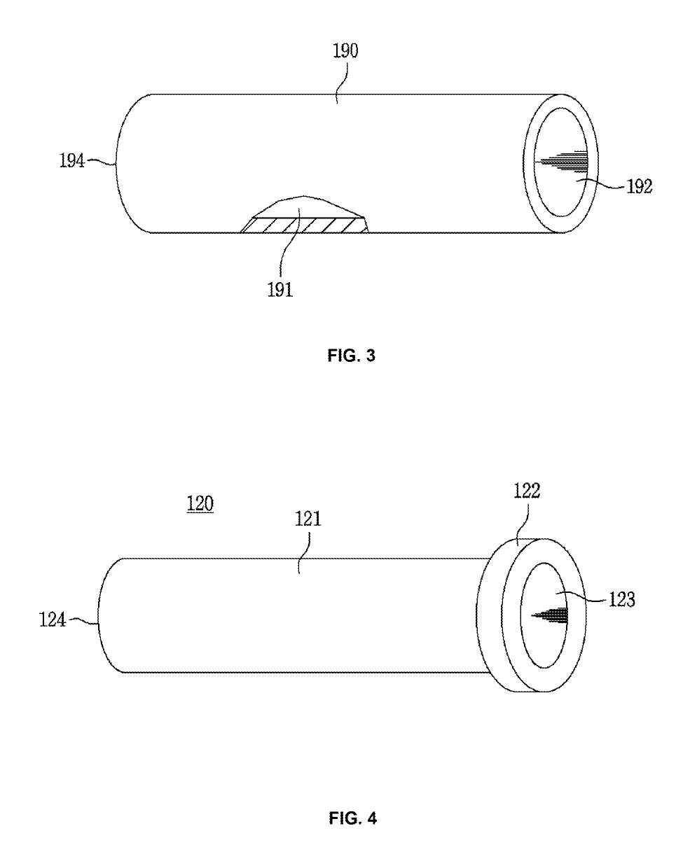

FIG. 3 is a perspective view illustrating an insulating housing.

The housing 190 is formed of an insulating material such as ceramic or plastic (synthetic resin), and is provided with an internal space 191 having a cylindrical shape in which an opening 192 is formed at one end thereof and a bottom 194 is formed at the other end thereof. However, the embodiment of the present invention is not limited to this structure, and the shape may be a cylindrical shape both ends of which are open or a shape of various cylinders.

<Conductive Member 120>

FIG. 4 is a perspective view illustrating a conductive member.

The conductive member 120 includes a body 121 in which an opening 123 is formed on one end thereof and a bottom 124 is formed on the other end thereof, and a connection part 122 which is bent outwardly from an edge of the opening 123 toward the other end to be integrally formed.

In other words, the housing 190 includes a capsule-shaped body 121 inserted into the internal space 191 of the housing 190, and a connection part 122 for electrical connection at the outer surface of the housing 190.

In this embodiment, the length of the body 121 has a length of such a degree that the bottom 124 of the body 121 contacts the bottom 194 of the housing 190. However, the embodiment of the present invention is not limited thereto, and the body 121 may be spaced apart from the bottom 194 of the housing 190.

When the body 121 is inserted into the internal space 191 of the housing 190 and forcibly pressed thereinto, an edge of one end of the housing 190 is inserted between the body 121 and the connection part 122, and thereby the conductive member 120 is coupled to the housing 190.

In this embodiment, the conductive member 120 having a specific shape is illustrated as an example as illustrated in FIG. 4, but the embodiment of the present invention is not limited thereto, and the conductive member 120 may be a conductive foil, such as a metal foil or a metal plated layer.

What is important is that the conductive member 120 functions to electrically connect the inside to the outside of the housing 190. To this end, it should be noted that the connection part 122 or a structure equivalent thereto should be provided.

<Bushing 160>

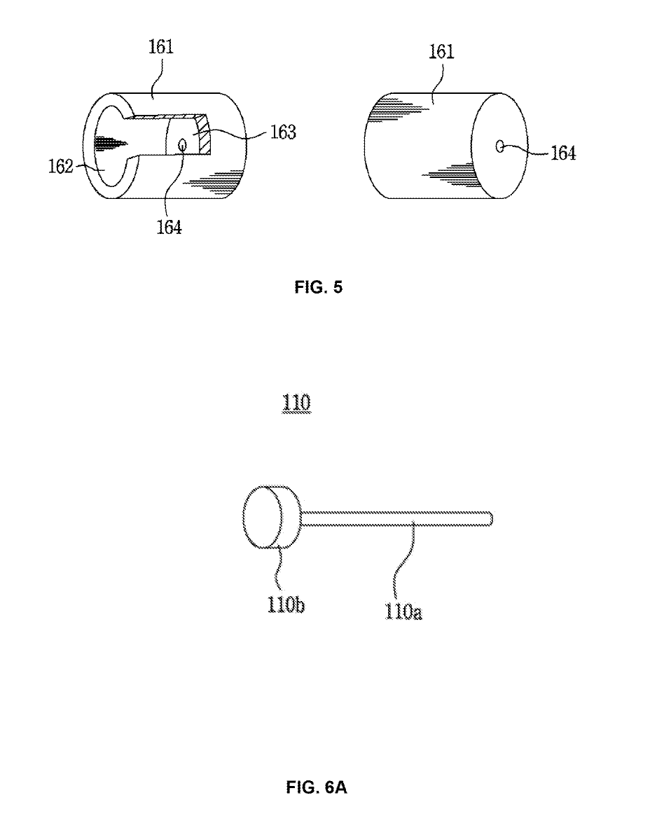

FIG. 5 is a perspective view illustrating a bushing.

The bushing 160 is formed of an insulating material such as plastic, and composed of a single cylindrical body 161.

An opening 162 is formed at one end of the body 161, a bottom 163 is formed at the other end, and a through-hole 164 is formed at the bottom 163, and as described below, a first lead 110 is inserted into the through hole 164 to be fixed thereto.

<First and Second Leads 110 and 112>

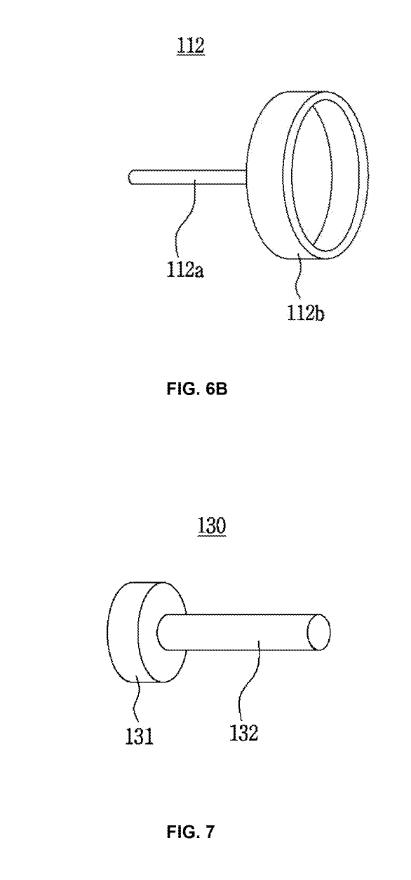

FIGS. 6A and 6B respectively illustrate a first lead and a second lead.

The first lead 110 is composed of a rod-shaped body part 110a and a disk-shaped contact part 110b integrally formed at one end of the body part 110a, but this is merely an example, and the first lead 110 may be provided in various shapes as long as the first lead 110 can pass through the bushing 160 to be fixed thereto.

In this example, the cross-sectional area of contact part 110b is formed greater than that of the body part 110a so that the contact part 110b may be blocked by the bottom 163 of the bushing 160, but the embodiment of the present invention is not limited thereto.

The body part 110a of the first lead 110 is forcibly inserted into the through-hole 164 of the bushing 160 to be fixed thereto, but an epoxy resin is applied to an exposed surface of the bushing 160 such that the first lead 110 may be firmly fixed.

The second lead 112 is composed of a rod-shaped body part 112a and a disk-shaped coupling part 112b integrally formed at one end of the body part 112a, but this is merely an example, and the second lead 112 may be provided in various shapes as long as the second lead 112 can be coupled to the other end of the housing 190 to be fixed thereto.

In this example, the coupling part 112b is formed in a cup shape and may be easily fitted and inserted into the other end of the housing 190, for example, may be coupled thereto through a mechanical forcible press-fitting method.

<Mover 130>

FIG. 7 is a perspective view illustrating a mover.

The mover 130 separates and supports the main spring 140 and the bias spring 150, and may have any configuration as long as the mover 130 can make an electrical contact with the first lead 110.

Referring to FIG. 7, the mover 130 is formed of a conductive material such as metal or metal alloy, and includes a disk-shaped supporter 131 having a diameter of such a degree that is accommodated in the internal space 191 of the housing 190 and can be moved therein, and a rod-shaped contact part 132 integrally extending from the center of the supporter 131 perpendicularly to the supporter 131.

In this example, the mover 130 is disposed such that the contact part 132 faces the side of the first lead 110 and is inserted into the main spring 140.

<Main Spring 140>

The main spring 140 is formed of a material such as metal or metal alloy, and as described above, is disposed between the mover 130 and the first lead 110 to maintain a compressed state.

One end of the main spring 140 is supported by the supporter 131 of the mover 130, and the other end of the main spring 140 contacts an edge of the opening 162 of the bushing 160. Accordingly, the inner diameter of the main spring 140 should be equal to or greater than that of the opening 162 of the bushing 160.

Also, as described later, when the mover 130 is not used, the main spring 140 may have a smaller diameter than that of the bushing 160 so that the main spring 140 may be compressed or extended inside the bushing 160, and a single spring may be used without being separated from the bias spring 150 described below.

<Bias Spring 150>

The bias spring 150 is formed of a material such as metal or metal alloy, and as described above, is disposed between the mover 130 and the bottom 124 of the conductive member 120 to maintain a compressed state.

One end of the bias spring 150 is supported by the supporter 131 of the mover 130, and the other end of the bias spring 150 contacts the fusible body 170 placed on the bottom 124 of the conductive member 120.

The compressive force of the bias spring 150 is set slightly greater than that of the main spring 140 such that the mover 130 may be moved toward the first lead 110 by the restoring force of the bias spring 150 while both the main spring 140 and the bias spring 150 are compressed.

Also, the bias spring 150 not only allows the contact part 132 of the mover 130 to elastically contact the first lead 110 but also functions to press the mover 130 so as to reliably maintain the contact, and therefore, the bias spring 150 may not be provided optionally, and in this case, the mover 130 directly contacts the fusible body 170.

<Fusible Body 170>

The fusible body 170, for example, a temperature fuse, and may be formed of conductive metal or metal alloy having the melting point of less than approximately 250° C.

The conductive metal may be tin (Sn), which is a metal having the melting point of approximately 231.93° C. and having a property of being melted at a temperature of approximately 232° C. or more.

The metal alloy may be a tin alloy composed of an alloy of tin and one or more kinds of metals selected from Ag, Cu, Zn, Cd, Sb, Bi, In, Ga or Pb, for example, may be Sn—Bi, Sn—Zn, Sn—Be, Sn—Ag—Cu—Bi, Sn—Bi—Ag, Sn—Bi—In, or the like. The Sn—Ag—Cu—Bi alloy has a melting point of approximately 205° C. to approximately 220° C., and the Sn—Bi—Ag alloy has a melting point of approximately 130° C. to approximately 180° C. When the Sn—Bi—Ag alloy is used, a temperature fuse having a melting point of approximately 100° C. may be manufactured.

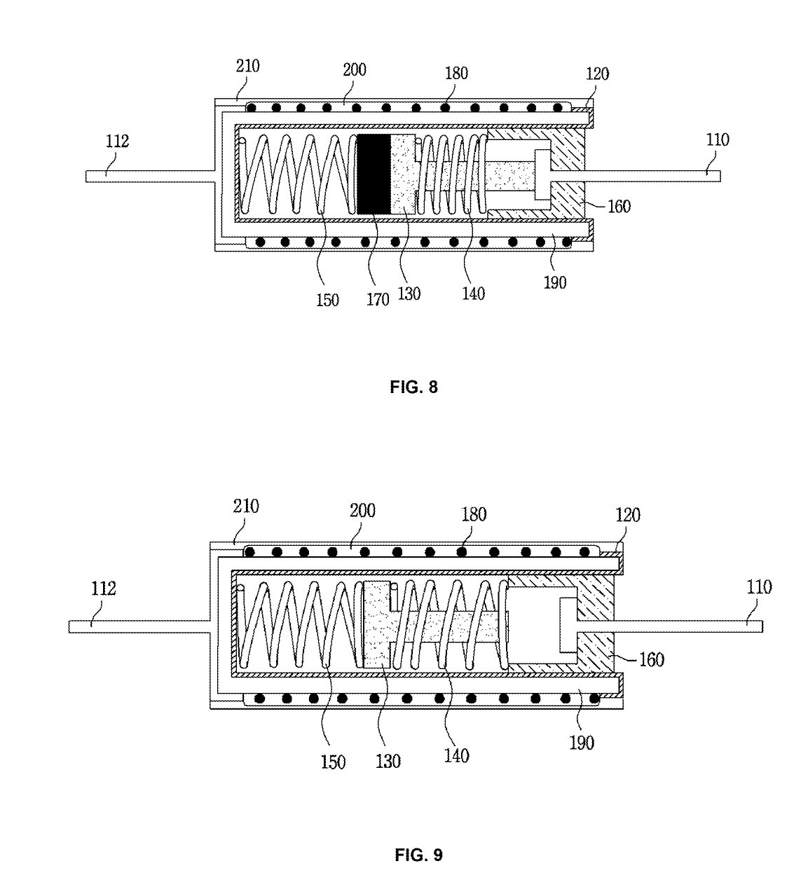

In this example, the fusible body 170 is disposed so as to be mounted on the bottom 124 of the conductive member 120 to be pressed by the other end of the bias spring 150, but the embodiment of the present invention is not limited thereto, and as illustrated in FIG. 8, the fusible body 170 may be disposed so as to be mounted on the other side of the mover 130 to be pressed by the one end of the bias spring 150.

Also, the fusible body 170 may be a solder (soldering lead), a solder pellet, or a solder ball, and this will be described later.

Especially, the greater the thickness of the fusible body 170, the more surely a short circuit of an electrical connection can be ensured, but it is necessary to determine the size of the fusible body 170 in consideration of the size of the safety apparatus 100 itself.

<Resistor 180>

The resistor 180 is formed on the outer surface of the housing 190 and electrically contacts the conductive member 120 and the second lead 112.

In this example, the resistor 180 may be a wire resistor wound on the outer surface of the housing 190 in a coil shape, but the embodiment of the present invention is not limited thereto, and the resistor 180 may be a thin film-shaped resistor.

In case of the wire resistor 180, one end of thereof is welded to the coupling part 112b of the second lead 112, and the other end thereof is welded to the conductive member 120.

The wire resistor 180 may be formed of a resistance wire of Ni—Cr, Ni—Fe—Cr, or the like, and may function to protect a surge. That is, when a surge is introduced, the wire resistor 180 absorbs the surge and generates heat.

<Protective Member 210>

The surface of the resistor 180 is coated with an insulating resin or an inorganic paint such as UV epoxy to form a surface protecting layer 200, and a protective member 210 such as a thermal contraction tube or a plastic case so as to cover the resistor 180, the coupling part 112b of the second lead 112 and the connection part 122 of the conductive member 210.

<Operation of Safety Apparatus>

Hereinafter, referring to FIGS. 1 to 7, the operation of a safety apparatus according to the present invention will be described.

First, the process of assembly will be simply described as follows.

The conductive member 120 is inserted into the internal space 191 of the housing 190, the bias spring 150 is then fixed to one side of the internal space 191 while the fusible body 170 is accommodated in the internal space 191, and the mover 130 on which the main spring 140 is fixed is then inserted into the other side of the internal space 191, and then the bushing 160 in which the first lead 110 is inserted is fixed by being forcibly inserted from the opening 192 of the housing 190.

Subsequently, the second lead 112 is mechanically coupled to the other end of the housing 190 by being forcibly inserted, one end of the resistor 180 is then welded to the second lead 112, the resistor 180 is then wound on the outer surface of the housing 190, and then the other end of the resistor 180 is welded to the conductive member 120.

Subsequently, the surface protective layer 200 is formed on the resistor 180 by a surface coating treatment with an insulating resin or an inorganic paint, and the protective member 210 is then inserted so as to cover the resistor 180, the coupling part 112b of the second lead 112, and the connection part 122 of the conductive member 120.

In an initial state in which the assembly is completed, the main spring 140 and the bias spring 150 are in compressed states and thereby maintain an electrical connection such that the contact part 132 of the mover 130 contacts the first lead 110.

Referring to FIG. 2B, when the housing 100 is overheated, or an overcurrent or an overvoltage is applied such that the temperature inside the housing 190 is raised higher than the melting point of the fusible body 170, the fusible body 170 is melted such that only remainders 172 remain, and thereby the bias spring 150 is recovered by the decreased distance due to the melting and disappearing of the fusible body 170. As a result, the compressive force of the bias spring 150 is decreased, and therefore, the mover 130 is pushed towards the opposite side of the first lead 110 by the restoring force of the main spring 140.

Accordingly, the electrical connection is disconnected as the contact part 132 of the mover 130 is separated from the first lead 110.

FIG. 9 illustrates a complex safety apparatus according to another embodiment of the present invention.

In this embodiment, a fusible body 170 is not provided, a main spring 140 is formed of a shape memory alloy, and a bias spring 150 is formed of a material such as metal and metal alloy.

The shape memory alloy, as well known, means an alloy, such as a nickel-titanium alloy, in which a shape memory effect is used and which has a phenomenon of returning to an original shape thereof when being heated no matter how strong the deformation is applied at a low temperature.

According to this example, while the main spring 140 and the bias spring 150 are compressed, the restoring force of the bias spring 150, when the temperature of the shape memory alloy constituting the main spring 140 is lower than the transformation temperature, is greater than that of the main spring 140, and the restoring force of the bias spring 150, when the temperature of the shape memory alloy constituting the main spring 140 is the transformation temperature or higher, is smaller than that of the main spring 140.

Thus, when the housing 190 is overheated or an overcurrent or an overvoltage is applied such that the temperature inside the housing 190 becomes higher than the transformation temperature of the shape memory alloy, the main spring 140 returns to the original shape thereof by the shape memory effect, and the bias spring 150 is relatively compressed, so that the electrical connection between the first lead 110 and the mover 130 is disconnected while the mover 130 is moved to opposite side to the first lead 110.

In this embodiment, the main spring 140 is formed of a shape memory alloy, but the bias spring 150 may be formed of a shape memory alloy, and it is possible to use a single spring formed of a shape memory alloy without providing the mover 130.

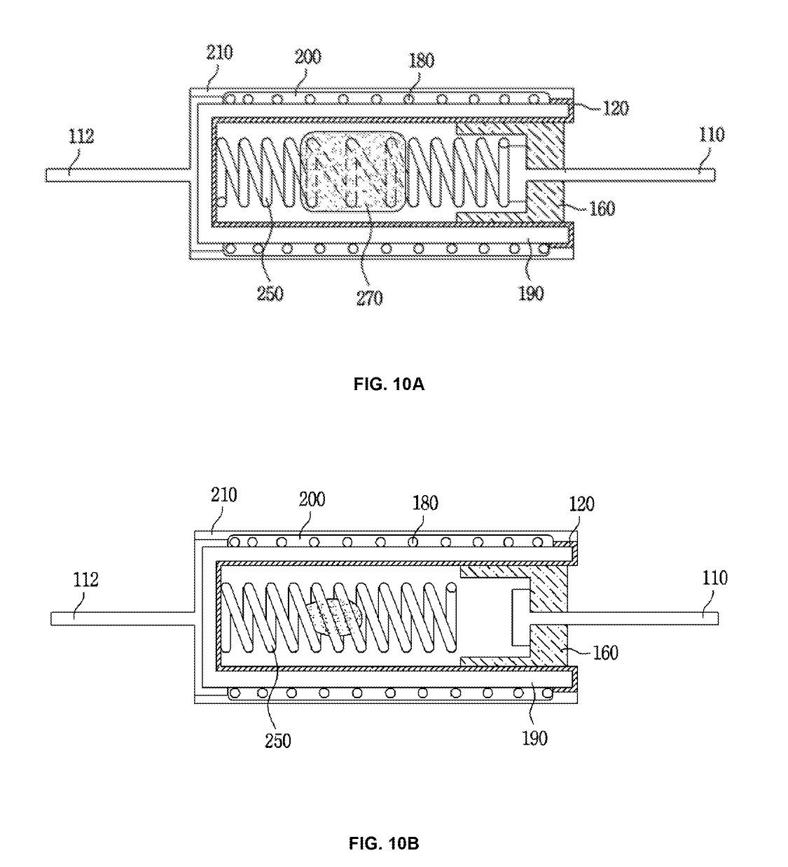

FIG. 10A illustrates a normal state of a complex safety apparatus according to another embodiment of the present invention, and FIG. 10B illustrates an electrically disconnected state.

According to this embodiment, a mover 130, a main spring 140, and a bias spring 150 are not provided, and an assembly of a tin-plated spring 250 and a solder 270 is positioned between a first lead 110 and a bottom 124 of a conductive member 120.

While the spring 250 is extended, molten solder is applied on a central portion of the spring 250 to surround the spring 250, and is cured to form the solder 270. Accordingly, the state in which only the central portion of the spring 250 is extended by the solder 270, that is, an extended state, is maintained.

In this state, one end of the spring 250 presses and contacts the first lead 110, and the other end of the spring 250 contacts and presses the bottom 124 of the conductive member 120.

Accordingly, as illustrated in FIG. 10B, when the housing 190 is overheated or an overcurrent or an overvoltage is applied and thereby the temperature inside the housing 190 is raised higher than the melting point of the solder 270, the solder 270 is melt, and the spring 250 is recovered and compressed by a decreased distance due to the melting and disappearing of the solder 270, so that the electrical connection is disconnected while one end of the spring 250 is separated from the first lead 110.

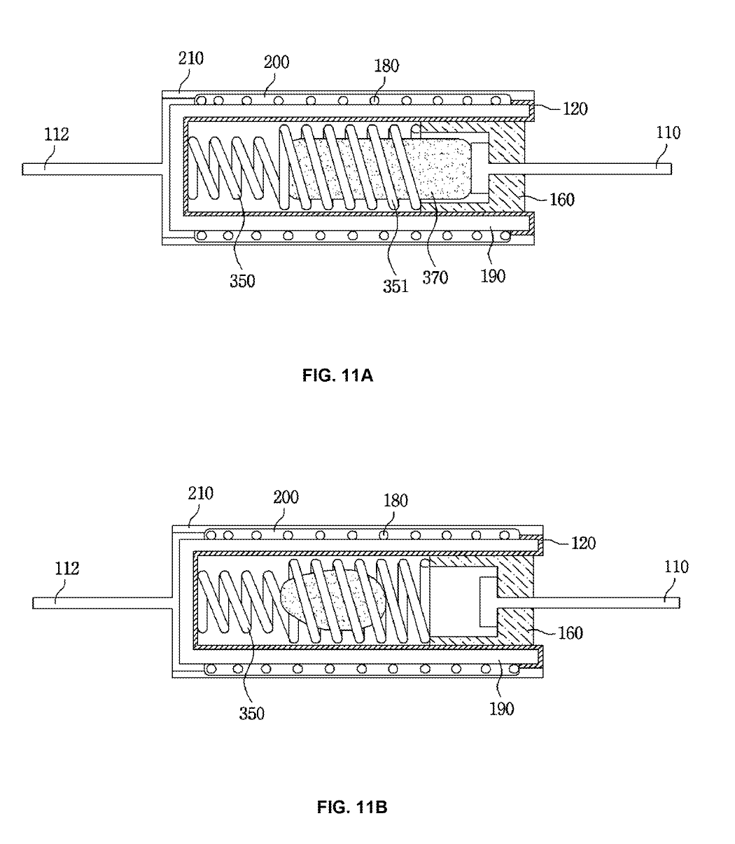

FIG. 11A illustrates a normal state of a complex safety apparatus according to another embodiment of the present invention, FIG. 11B illustrates an electrically disconnected state, and FIG. 11C illustrates another example.

According to this embodiment, a mover 130, a main spring 140, and a bias spring 150 are not provided, a tin-plated spring 350 is positioned between a bushing 160 and a bottom 124 of a conductive member 120, and a solder pellet 370 is inserted and coupled into a spring 350 at one end of the spring 350.

Here, a portion of the solder pellet 370 is protruded from the spring 350, and the protruded portion is pressed by the spring 350 and contacts the first lead 110.

As in this embodiment, the spring 350 may be composed of two parts having diameters different from each other such that the solder pellet 370 may be inserted into a large diameter part 351 or as illustrated in FIG. 11C, a spring 355 may be formed in a tapered shape such that the solder pellet 370 may be inserted into the spring 355 through an input hole with a large diameter.

In any cases, there is a merit in that the solder pellet 370 having a predetermined diameter can be accurately inserted at a predetermined depth.

The solder pellet 370 functions as a thermal fuse which is cut at a predetermined temperature or higher, and a flux may be further contained in the solder pellet 370. For example, a hole is formed in the solder pellet 370, a flux is then injected into the hole, and then the solder 370 can be used after being sealed.

According to this structure, as illustrated in FIG. 11B, when the housing 190 is overheated or an overcurrent or an overvoltage is applied such that the temperature inside the housing 190 is raised higher than the melting point of the solder pellet 370, the solder pellet 370 is melted, and the electric connection is disconnected while one end of the solder pellet 370 is separated from the first lead 110.

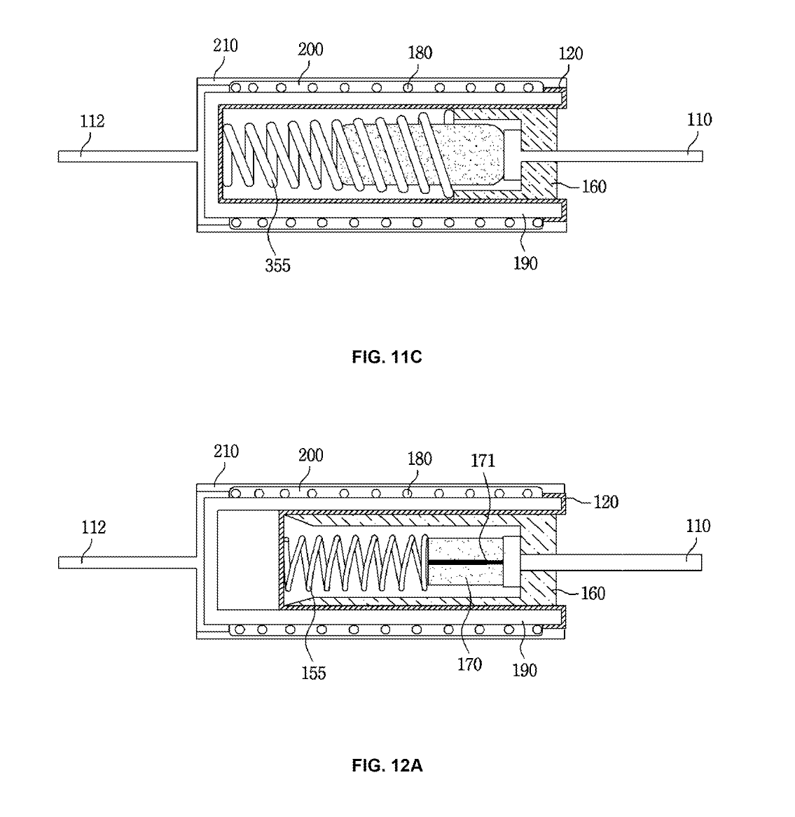

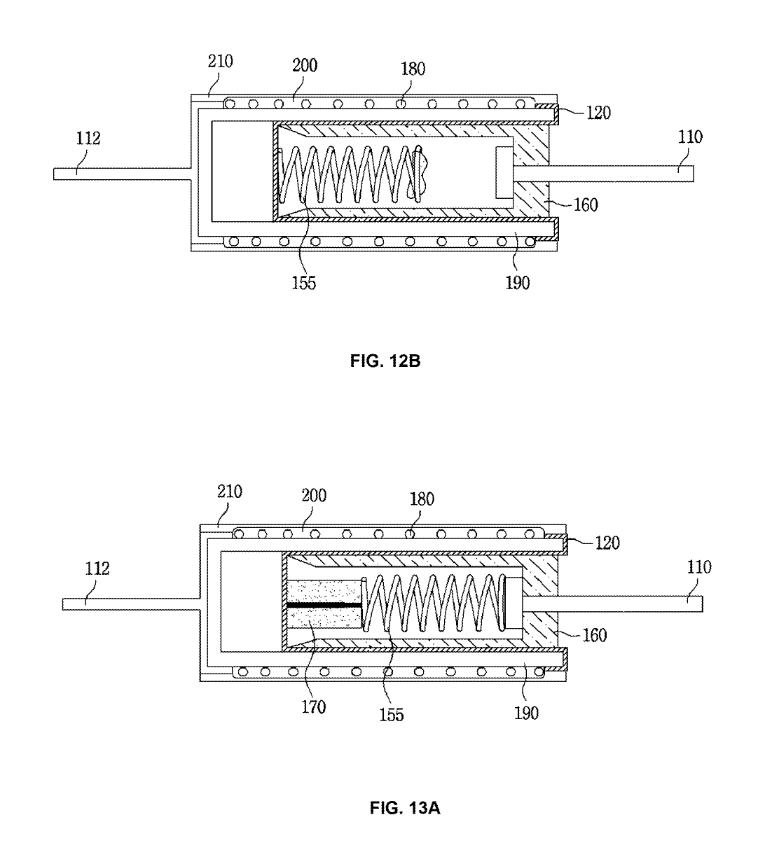

FIG. 12A illustrates a normal state of a complex safety apparatus according to another embodiment of the present invention, and FIG. 12B illustrates an electrically disconnected state.

According to this embodiment, a mover 130, a main spring 140, and a bias spring 140 are not provided, and a spring 155 and a fusible body 170 are positioned in serial between a first lead 110 and a bottom 124 of a conductive member 120.

In this embodiment, to reduce the length of the spring 155, the size of the conductive member 120 is reduced such that the bottom 124 of the conductive member 120 is spaced apart from a bottom 194 of a housing 190, but the embodiment of the present invention is not limited thereto.

Also, the length of a bushing 160 is allowed to be equal to the length of the conductive member 120 such that an end portion of the bushing 160 contacts the bottom 124 of the conductive member 120, and thereby the bushing 160 may always be inserted at an accurate position.

The fusible body 170 may be a solder pellet or a solder ball, and a flux 171 which functions to accelerate the melting by improving wettability may be injected thereinto.

In this embodiment, since the fusible body 170 is directly pressed by the compressed spring 155 to directly contact the first lead 110 to be electrically connected, a separate mover is not required.

As illustrated in FIG. 12B, when the housing 190 is overheated or an overcurrent or an overvoltage is applied such that the temperature inside the housing 190 is raised higher than the melting point of the fusible body 170, the fusible body 170 is melted, and the electric connection is disconnected while one end of the fusible body 170 is separated from the first lead 110. Here, the spring 155 is extended by a restoring force, and the extending length is allowed to be smaller than the length of the fusible body 170 such that the spring 155 does not contact the first lead 110.

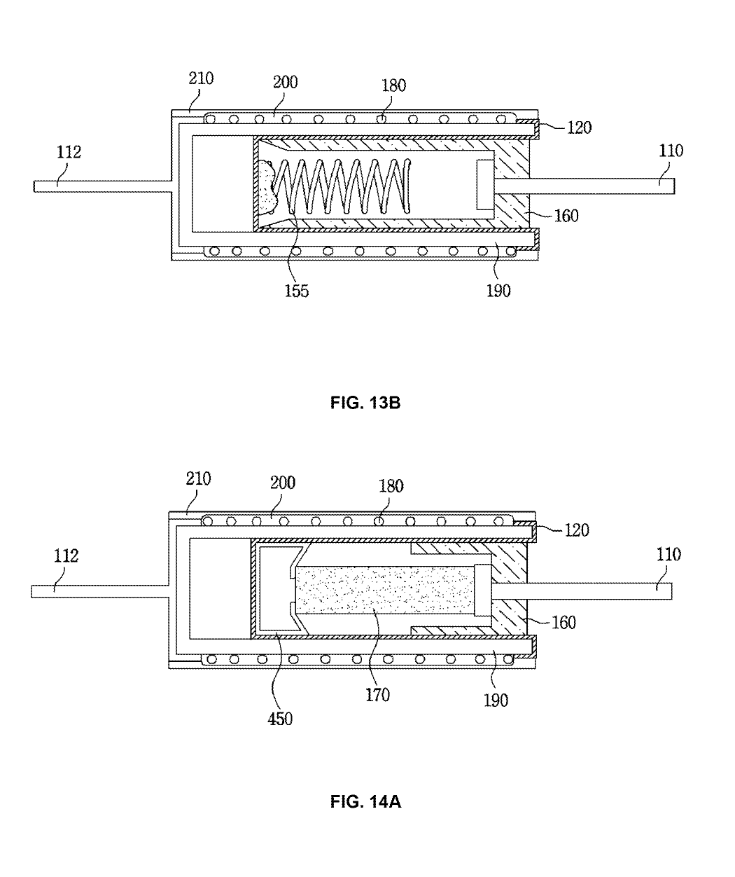

FIG. 13A illustrates a normal state of a modified example in which the fusible body in FIG. 12A is disposed at another position, and FIG. 13B illustrates an electrically disconnected state.

In this embodiment, a fusible body 170 is interposed between a spring 155 and a bottom 124 of a conductive member 120.

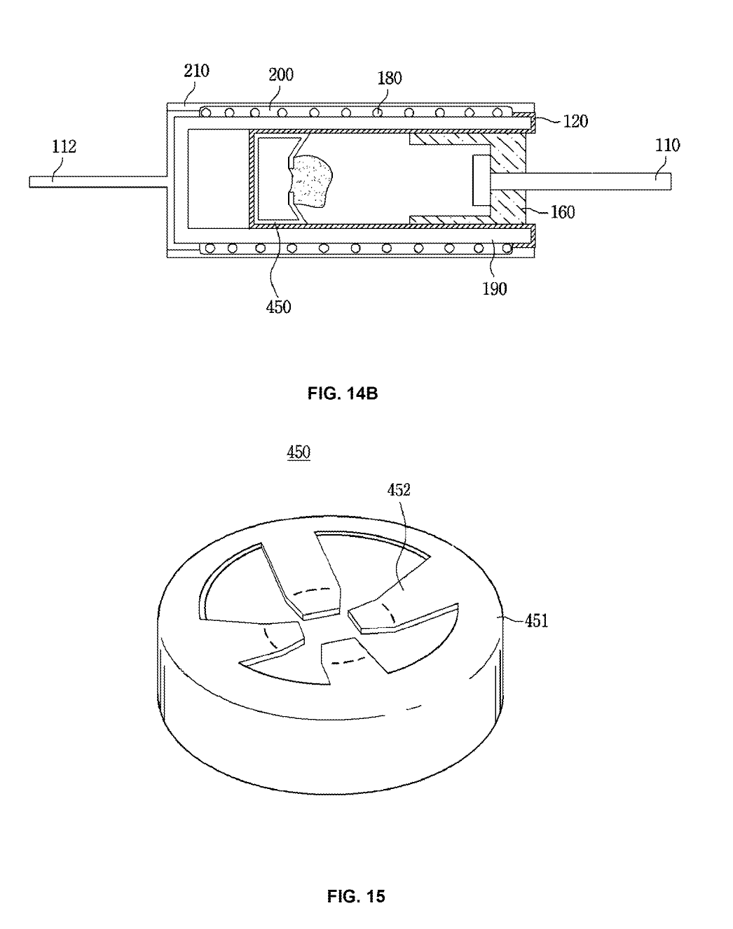

FIG. 14A illustrates a normal state of a complex safety apparatus according to another embodiment of the present invention, and FIG. 14B illustrates an electrically disconnected state.

According to this embodiment, a mover 130, a main spring 140, and a bias spring 140 are not provided, and a plate spring 450 and a fusible body 470 are positioned in serial between a first lead 110 and a bottom 124 of a conductive member 120.

Referring to FIG. 15, a plate spring 450 formed of a material such as metal or metal alloy, for example, stainless steel, includes a cylindrical sidewall 451 and a plurality of forks 452 which are spaced apart from each other and extend from an upper end of the sidewall 451 toward the inside of the plate spring 450. The forks 452 function as a plate spring to elastically support the fusible body 470 such that the fusible body 470 contacts the first lead 110.

The fusible body 470, as described above, may be provided as a single solder pellet or solder ball or multiple solder pellets or solder balls.

Referring to FIG. 14B, when the housing 190 is overheated or an overcurrent or an overvoltage is applied such that the temperature inside the housing 190 is raised higher than the melting point of the fusible body 470, the fusible body 470 is melted, and the electric connection is disconnected while fusible body 470 is melted and disappeared to be separated from the first lead 110.

According to the above-mentioned structure, components assembled inside an electronic device such as a mobile device or a charger may be complexly protected from overheating, an overcurrent, a surge, or the like.

Also, due to a fusible body provided inside, a structure is simple, and manufacturing costs can be reduced.

Also, since both leads are implemented in a straight-line shape so as to be symmetrical to each other, a simple assembly and an automatic assembly can be achieved, a process such as lead bending is not required, and thus components can be miniaturized.

Also, since both leads are spaced apart from each other in directions opposite to each other, a high voltage resistance can be achieved.

While exemplary embodiments of the present invention has been described in detail, it should be understood that the present invention is not limited thereto, and the various changes, substitutions and alterations can be made hereto by those skilled in the art without departing from the spirit and scope of the invention.

What is claimed is:

1. An integral complex safety apparatus comprising:
an insulating housing having one open end and provided with an internal space;
a conductive member disposed in the internal space and extending to an outer surface of the housing;
an insulating bushing inserted into and installed in the internal housing from the open end;
a first lead passing through and fixed to the insulating bushing;
a spring disposed in the internal space;
a fusible body disposed in the internal space;
a resistor disposed on the outer surface of the insulating housing and electrically connected to the conductive member; and
a second lead coupled to the other end of the housing and electrically connected to the resistor, wherein
the first lead and the conductive member are electrically connected to each other by a restoring force due to compression of the spring and the first lead and the conductive member are electrically separated from each other by the melting of the fusible body.

2. The integral complex safety apparatus of claim 1, wherein
the fusible body is coupled to the spring such that while a predetermined portion of the spring is extended, the fusible body is applied to the predetermined portion of the spring to surround the predetermined portion and is cured, whereby both ends of the spring respectively contact the first lead and the conductive member.

3. The integral complex safety apparatus of claim 1, wherein the fusible body is inserted into an inside of the spring from one end of the spring such that a portion thereof is exposed to the outside,
the other end of the spring contacts the conductive member, the one end of the spring contacts the bushing to be blocked by the bushing, and
a protruded portion of the fusible body contacts the first lead by a restoring force due to compression of the spring.

4. The integral complex safety apparatus of claim 1, further comprising
a mover movably disposed in the internal space, wherein
the spring comprises a main spring interposed between the mover and the first lead to be supported by the mover, and a bias spring interposed between the mover and the conductive member, wherein
the fusible body is interposed between the bias spring and the conductive member or between the bias spring and the mover.

5. The integral complex safety apparatus of claim 1, wherein
one end of the spring and one end of the fusible body are disposed in serial so as to contact each other,
the other end of the spring contacts the conductive member, and the other end of the fusible body contacts the first lead, and
an extending length of the spring is smaller than a length of the fusible body due to the melting of the fusible body.

6. The integral complex safety apparatus of claim 1, wherein
one end of the spring and one end of the fusible body are disposed in serial so as to contact each other,
the other end of the spring contacts the first lead, and the other end of the fusible body contacts the conductive member, and
an extending length of the spring is smaller than a length of the fusible body due to the melting of the fusible body.

7. The integral complex safety apparatus of claim 1, wherein
the spring is a plate spring comprising a cylindrical sidewall and a plurality of forks spaced apart from each other, the forks extending from an upper end of the cylindrical sidewall to the inside of the spring, and
a lower end of the sidewall contacts the conductive member, and the one end of the fusible body is elastically supported by the forks.

8. The integral complex safety apparatus of claim 1, wherein the conductive member comprises a cylindrical body having an opening formed at one end thereof and a bottom formed on the other end thereof, and a connection part bent outward from an edge of the opening toward the other end to be integrally formed at the one end.

9. The integral complex safety apparatus of claim 1, wherein the second lead comprises a rod-shaped body part, and a cup-shaped coupling part integrally formed at one end of the body part such that the coupling part is coupled to the other end of the housing.

10. The integral complex safety apparatus of claim 1, wherein the fusible body is a temperature fuse or a solder comprising a solder pellet or a solder ball.

11. The integral complex safety apparatus of claim 1, wherein the resistor is a wire resistor both ends of which are electrically connected to the conductive member and the second lead respectively, and which is wound in a coil shape on an outer surface of the housing.

12. An integral complex safety apparatus comprising:
an insulating housing having one open end and provided with an internal space;
a conductive member disposed in the internal space and extending to an outer surface of the housing;
an insulating bushing inserted into and installed in the internal space from the open end;
a first lead passing through and fixed to the insulating bushing;
a mover movably installed in the internal space;
a main spring interposed between the mover and the first lead to be supported by the mover, and formed of a shape memory alloy;
a bias spring interposed between the mover and the conductive member;
a resistor installed on the outer surface of the housing and electrically connected to the conductive member; and
a second lead coupled to the other end of the housing and electrically connected to the resistor, wherein
the first lead and the conductive member are electrically connected by a restoring force due to compression of the spring and the first lead and the conductive member are electrically separated by deformation of the main spring.
